(19) United States
(12) Patent Application Publication
(10) Pub. No.: US 2008/0011163 A1
(43) Pub. Date: Jan. 17, 2008

(54) Sorbent porous polymeric composite materials

(76) Inventor: Michael S. McClain, Ortonville, MI (US)

Correspondence Address: DELPHI TECHNOLOGIES, INC., M/C 480-410-202, PO BOX 5052, TROY, MI, 48007, US

(21) Appl. No.: 11/487,922

(22) Filed: Jul. 17, 2006

(51) Int. Cl. B01D 53/02

(52) U.S. Cl. 96/108

(57) ABSTRACT

A composite material includes a porous polymeric material and a plurality of sorbent particles integrated into the porous polymeric material.

### BACKGROUND

The present disclosure relates generally to composite materials, and more particularly to sorbent porous polymeric composite materials.

Many oxygen concentrators contain numerous components for housing adsorptive materials therein. These components often include screened housings or porous housings having small enough apertures to contain the adsorptive material and simultaneously allow air to flow therethrough. Such components require that the adsorptive material be larger than the apertures, thus substantially eliminating the possibility of using any desirable small adsorptive material. Such concentrators utilize Pressure Swing Absorption (PSA) to extract the nitrogen out of the ambient gas mixture, thus concentrating the oxygen. A relatively larger sized adsorptive material may prevent faster cycle times and increased output from the concentrator by reducing the available surface area for absorption.

As such, it would be desirable to provide a material having any desirable sized adsorptive material that is suitable for use in an oxygen concentrator utilizing PSA.

### SUMMARY

A composite material is disclosed herein. The composite material includes a porous polymeric material and a plurality of sorbent particles integrated into the porous polymeric material.

### BRIEF DESCRIPTION OF THE DRAWINGS

Features and advantages of the present disclosure will become apparent by reference to the following detailed description and drawings, in which like reference numerals correspond to similar, though not necessarily identical components. For the sake of brevity, reference numerals or features having a previously described function may not necessarily be described in connection with other drawings in which they appear.

FIG. 1 is a perspective view of an embodiment of a sorbent porous polymeric composite material; and

FIG. 2 is a schematic view of an embodiment of an oxygen concentrator incorporating an embodiment of a sorbent porous polymeric composite material.

### DETAILED DESCRIPTION

Embodiments of the composite disclosed herein generally include a porous polymeric material having a sorbent/zeolite material incorporated therein. It is believed that the addition of the zeolite material to the porous polymeric material substantially reduces or eliminates handling powdered forms of zeolite when manufacturing a device in which it is used. Furthermore, the retainers and/or housings (e.g., having apertures suitable for containing the zeolite and allowing air flow) associated with the granular zeolite may also be substantially reduced or eliminated from the device. As the embodiments of the composite incorporate the zeolites directly therein (rather than containing them in a porous or screened housing), it is believed that zeolites having smaller, or variable, particle sizes may be used. Still further, the composite material may be formed to a desirable size, shape, and/or configuration and/or may be cut to a desirable length for various applications.

The composite disclosed herein may advantageously be used in any desirable gas separation device and/or process. A non-limitative example of such a device is an oxygen concentrator, and a non-limitative example of such a process is a natural gas treatment. It is believed that zeolites having a smaller particle size may advantageously decrease cycle times and output of pressure swing absorption (PSA) systems. The size of the zeolites may also offer a small, compact design for molecular sieve applications.

Although, as mentioned herein, zeolite particles are contemplated as being useful in various embodiment(s) of the present disclosure, it is to be understood that various sorbents suitable for use in embodiment(s) described herein may be used. Zeolites are one non-limitative example of sorbents.

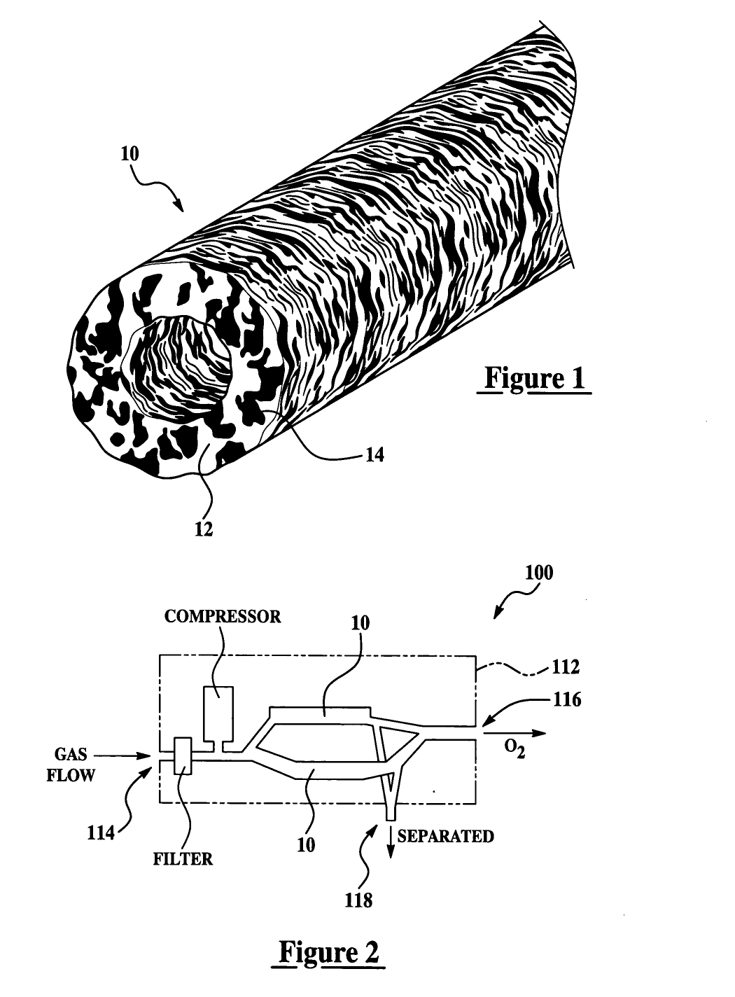

Referring now to FIG. 1, a composite material 10 is provided including a porous polymeric material 12 and a plurality of sorbent particles 14 (e.g. zeolite particles) integrated into the porous polymeric material 12. As such, an embodiment of the method of making the composite material 10 includes forming a porous polymeric material 12 and integrating the plurality of zeolite particles 14 into the porous polymeric material 12.

It is to be understood that the porous polymeric material 12 may be purchased, or may be formed from the polymerization of monomers.

The integration of the plurality of zeolite particles 14 may be accomplished by any suitable technique, depending, at least in part, upon the specific composition of the porous polymeric material 12 and/or the zeolite particles 14. In an embodiment, integrating the plurality of zeolite particles 14 is accomplished by molding, impregnating, sintering (e.g., those sintering processes used with high temperature materials, metals (e.g., brass or bronze), etc.), extrusion processes, spray processes, foam formation processes, bubble formation processes, and/or combinations thereof.

It is to be understood that forming the porous polymeric material 12 and integrating the zeolite particles 14 therein may occur substantially simultaneously or sequentially.

The porous polymeric material 12 may be a non-hydroscopic material, or one that is substantially incapable of absorbing water. Non-limitative examples of such porous polymeric materials 12 include polypropylene, polyethylene, polystyrene, polyisobutylene, copolymers of styrene-butadiene, polybutadiene, some hydrophobic polyurethanes, and/or combinations thereof. In a non-limitative example, polypropylene beads and/or polyethylene beads may be bonded together to form porous filters of various shapes.

Generally, the sorbent particles 14 may be incorporated for gas separation and/or purification of an oxygen containing gas stream. In an embodiment, the sorbent particles 14 are capable of adsorbing nitrogen gas and/or some other gas(es) from a gas stream. Non-limitative examples of suitable sorbents for gas separation include zeolites commercially available from Tricat Zeolites GmbH, located in Bitterfeld, Germany; zeolites commercially available from UOP, located in Des Plaines, Ill.; Li-LSX beads; zeolite X; zeolite Y; zeolite LSX; MCM-41 zeolites; activated carbon; activated alumina; and/or silicoaluminophosphates (SAPOS); and/or combinations thereof.

In an embodiment of the composite material 10, each of the plurality of zeolite particles 14 may have a size ranging from about 100 microns to about 2,000 microns. It is to be understood that the size of the zeolite particles 14 may be adapted for a specific application. More specifically, the particle 14 size may be adapted for exposure to a predetermined gas flow or for forming the composite 10 so that it has a predetermined filtration ratio.

In an embodiment, the composite material 10 includes about 40% of the porous polymeric material 12 and about 60% of the zeolite particles 14. In another embodiment, the composite 10 includes the porous polymeric material 12 in an amount ranging from about 5% to about 70%, and the plurality of zeolite particles 14 in an amount ranging from about 30% to about 95%. In still another embodiment, the composite 10 includes the porous polymeric material 12 in an amount ranging from about 5% to about 40%, and the plurality of zeolite particles 14 in an amount ranging from about 60% to about 95%. It is to be understood that the ratio of polymeric material 12 to zeolite particles 14 may be adapted to provide the composite 10 with predetermined properties, such as, for example strength and/or adsorptivity. It is to be further understood that any suitable ratio of polymeric material 12 to zeolite particles 14 may be utilized, and the ratio may be adapted for a specific application, or to realize predetermined stress and/or strain ratings.

Referring now to FIG. 2, a schematic diagram of an oxygen concentrator/concentration device 100 is depicted. In an embodiment, the oxygen concentration device 100 includes a housing 112 having an inlet 114 for introduction of a gas stream, a first outlet 116 for oxygen gas removal, and a second outlet 118 for separated gas removal. The oxygen concentrator 100 includes an embodiment of the zeolite porous polymeric composite material 10 established within the housing 112. As depicted, the composite 10 is configured to adsorb and separate at least one undesirable gas (e.g., nitrogen gas) from the gas stream, and purge it out of the concentrator 100, so as to substantially regenerate the filtration capacity and/or adsorptive capacity of the composite material 10.

Embodiments of the composite material 10 disclosed herein include, but are not limited to the following advantages. The composite material 10 may advantageously be used in any desirable gas separation device and/or process. As the composite material 10 includes the sorbent particles 14 in the porous polymeric material 12, it is believed that smaller particle sizes may be used, if desired. Without being bound to any theory, it is believed that these smaller sized sorbent particles 14 may offer a small, compact design for molecular sieve applications. Furthermore, the size of the sorbent particles 14 advantageously decreases cycle times and output of pressure swing absorption (PSA) systems.

Still further, the addition of the sorbent particles 14 to the porous polymeric material 12 may substantially reduce or eliminate handling powdered forms of sorbent when manufacturing a device in which it is used. Still further, the composite material 10 may be formed to a desirable size, shape, and/or configuration and/or may be cut to a desirable length for a variety of applications (non-limitative examples of which include oxygen concentration, natural gas treatment, or the like).

While several embodiments have been described in detail, it will be apparent to those skilled in the art that the disclosed embodiments may be modified. Therefore, the foregoing description is to be considered exemplary rather than limiting.

What is claimed is:

1. A composite material, comprising:
a porous polymeric material; and
a plurality of sorbent particles integrated into the porous polymeric material.

2. The composite material as defined in claim 1 wherein the sorbent particles are zeolite particles, and wherein each of the plurality of zeolite particles has a size ranging from about 100 microns to about 2,000 microns.

3. The composite material as defined in claim 1 wherein the plurality of sorbent particles is capable of adsorbing nitrogen gas.

4. The composite material as defined in claim 1 wherein the porous polymeric material is a non-hydroscopic material.

5. The composite material as defined in claim 1 wherein the porous polymeric material is selected from polypropylenes, polyethylenes, polystyrenes, polyisobutylenes, copolymers of styrene-butadiene, polybutadienes, hydrophobic polyurethanes, and combinations thereof.

6. The composite as defined in claim 1 wherein the composite includes about 40% of the porous polymeric material and about 60% of the plurality of sorbent particles.

7. The composite as defined in claim 1 wherein the composite includes the porous polymeric material in an amount ranging from about 5% to about 70%, and the plurality of sorbent particles in an amount ranging from about 30% to about 95%.

8. A method of making a composite material, comprising:
forming a porous polymeric material; and
integrating a plurality of sorbent particles into the porous polymeric material.

9. The method as defined in claim 8 wherein the sorbent particles are zeolite particles, and wherein integrating the plurality of zeolite particles is accomplished by at least one of molding, sintering, extruding, impregnating, spray, foam, bubble formation, or combinations thereof.

10. The method as defined in claim 8 wherein forming and integrating occur substantially simultaneously.

11. The method as defined in claim 8 wherein forming and integrating occur sequentially.

12. An oxygen concentration device, comprising:
a housing having an inlet for introduction of a gas stream;
a composite material established within the housing, the composite material adapted to adsorb and separate at least one undesirable gas from the gas stream, and the composite material including:
a porous polymeric material; and
a plurality of sorbent particles integrated into the porous polymeric material;
a first outlet for removal of the at least one undesirable gas; and
a second outlet for removal of the gas stream having the at least one undesirable gas removed therefrom.

13. The oxygen concentration device as defined in claim 12 wherein the sorbent particles are zeolite particles, and wherein each of the plurality of zeolite particles has a size ranging from about 100 microns to about 2,000 microns.

14. The oxygen concentration device as defined in claim 12 wherein the at least one undesirable gas is nitrogen gas.

15. The oxygen concentration device as defined in claim 12 wherein the porous polymeric material is a non-hydroscopic material.

16. The oxygen concentration device as defined in claim 12 wherein the porous polymeric material is selected from polypropylenes, polyethylenes, polystyrenes, polyisobutylenes, copolymers of styrene-butadiene, polybutadienes, hydrophobic polyurethanes, and combinations thereof.

17. The oxygen concentration device as defined in claim 12 wherein the composite material includes about 40% of the porous polymeric material and about 60% of the plurality of sorbent particles.

18. The oxygen concentration device as defined in claim 12 wherein the composite material includes the porous polymeric material in an amount ranging from about 5% to about 70%, and the plurality of sorbent particles in an amount ranging from about 30% to about 95%.
